(19) United States
(12) Patent Application Publication
(10) Pub. No.: US 2012/0326649 A1
(43) Pub. Date: Dec. 27, 2012

(54) Systems and Methods for Operating a Solar Direct Pump

(75) Inventors: Amiya Patanaik, Bhubaneswar (IN); Gangaram Posannapeta, Secunderabad (IN); Govardhanrao Gariki, Visakhapatnam (IN); Piyush Shroff, Kolkata (IN)

(73) Assignee: SOLAR SEMICONDUCTOR, INC., Santa Clara, CA (US)

(21) Appl. No.: 13/581,911

(22) PCT Filed: Mar. 15, 2011
(86) PCT No.: PCT/US11/28454

§ 371 Date: Aug. 30, 2012

Related U.S. Application Data
(60) Provisional application No. 61/313,896, filed on Mar. 15, 2010.

(51) Int. Cl. H02P 7/06

(52) U.S. Cl. 318/453

(57) ABSTRACT

Systems and methods for operating a solar direct pump are provided. A system for controlling an alternating current (AC) pump includes a photovoltaic module, a temperature sensor that measures a temperature of the photovoltaic module, a calculator that calculates a maximum power point (MPP) voltage of the photovoltaic module based on the temperature of the photovoltaic module, and a frequency controller that adjusts a reference frequency of power supplied to the pump based on the MPP voltage.

### CROSS-REFERENCE TO RELATED APPLICATIONS

This application claims priority under 35 U.S.C. §119 to U.S. Provisional Patent Application No. 61/313,896, filed on Mar. 15, 2010, the contents of which are hereby incorporated by reference in their entirety.

### BACKGROUND OF THE INVENTION

As the cost of solar photovoltaic modules decreases, they are becoming increasingly popular as a green alternative to conventional sources of energy in both on-grid and off-grid situations. Systems employing solar photovoltaic modules are especially useful in remote locations and developing countries. Related art systems either use a linear current booster to power a direct current (DC) pump, or a battery charge controller and inverter to power an alternating current (AC) pump. Both of the related art systems are costly and require regular maintenance.

Related art systems that operate without a battery use a linear current booster that maintains a constant current at the output, sacrificing voltage under varying levels of irradiance, which allows them to run a DC pump at varying speeds. The speed and the power output are varied by changing the input voltage of the motor, while keeping the current constant. Although this technique is simple and efficient, the exorbitant price of DC pumps makes the overall system impractical. For example, DC pumps may be an order of magnitude more expensive than AC pumps.

DC pumps may or may not use brushed motors. Brushed DC pumps require regular maintenance, and use carbon slip rings that must be replaced regularly. Brushless DC pumps require less maintenance, but need much more complex control logic, which increases the cost of the system.

Related art systems that have a battery back-up use a charge controller to charge the battery, which is connected to an inverter that powers an AC pump. In these systems, maximum power point (MPP) tracking is performed by varying the duty ratio of the DC-DC converter in the charge controller. However, this method of MPP tracking is often unstable. Also, the use of a separate charge controller, battery, and inverter increases the overall size and cost of the system. Further, the battery increases the initial investment and subsequent maintenance costs. The battery must be frequently maintained and replaced. In addition, large losses occur during operation from charging and discharging the battery. The battery is bulky and heavy, and may render the system immobile,

Accordingly, it would be advantageous to develop a system that employs solar photovoltaic modules to power an AC pump without using a battery. It would also be advantageous to develop a method of MPP tracking that improves efficiency and stability.

### SUMMARY OF THE INVENTION

The present invention provides systems and methods for operating a solar direct pump. According to an aspect of the invention, there is provided a system for controlling an AC pump. The system includes a photovoltaic module, a temperature sensor that measures a temperature of the photovoltaic module, a calculator that calculates an MPP voltage of the photovoltaic module based on the temperature of the photovoltaic module, and a frequency controller that adjusts a reference frequency of power supplied to the pump based on the MPP voltage.

If a photovoltaic bus voltage exceeds a sum of the MPP voltage and a tolerance voltage, the frequency controller may increase the reference frequency. If the MPP voltage exceeds the photovoltaic bus voltage, the frequency controller may decrease the reference frequency.

The system may also include a voltage-to-frequency ratio (V/f) controller that adjusts V/f based on the MPP voltage. The V/f controller may adjust V/f to compensate for a voltage drop across a stator of an induction motor coupled to the pump. The V/f controller may be a variable voltage variable frequency (VVVF) drive.

The system may also include a braking resistor that is connected in parallel with the photovoltaic module, and a braking controller that dissipates excess energy in the braking resistor if a photovoltaic bus voltage exceeds a maximum voltage.

The system may also include a time delay comparator that compares the reference frequency with a minimum frequency, and a monoshot multivibrator that switches off the pump if the minimum frequency exceeds the reference frequency for a length of time. Further, the system may also include a comparator that compares the reference frequency with a maximum frequency; and a latch that switches off the pump if the reference frequency exceeds the maximum frequency.

According to another aspect of the invention, there is provided a method for controlling an AC pump. The method includes measuring a temperature of a photovoltaic module; calculating an MPP voltage of the photovoltaic module based on the temperature of the photovoltaic module; and adjusting a reference frequency of power supplied to the pump based on the MPP voltage.

The method may also include increasing the reference frequency if a photovoltaic bus voltage exceeds a sum of the MPP voltage and a tolerance voltage. In addition, the method may include decreasing the reference frequency if the MPP voltage exceeds a photovoltaic bus voltage.

The method may also include adjusting V/f based on the MPP voltage. V/f may be adjusted to compensate for a voltage drop across a stator of an induction motor coupled to the pump.

The method may also include dissipating excess energy in a braking resistor that is connected in parallel with the photovoltaic module if a photovoltaic bus voltage exceeds a maximum voltage. In addition, the method may include comparing the reference frequency with a minimum frequency, and switching off the pump if the minimum frequency exceeds the reference frequency for a length of time. Further, the method may include comparing the reference frequency with a maximum frequency, and switching off the pump if the reference frequency exceeds the maximum frequency.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates a simplified schematic of a system including photovoltaic modules connected in series, a capacitor, and a switching circuit that provide power to an induction motor coupled to a pump according to an exemplary embodiment of the invention;

FIG. 2 illustrates current vs. voltage characteristics of the photovoltaic modules used at a cell temperature of 25° C. for different levels of irradiance;

FIG. 3 illustrates power vs. voltage characteristics of the photovoltaic modules used at different module temperatures and a fixed irradiance;

FIG. 4 illustrates a schematic of the system shown in FIG. 1, together with various control blocks according to an exemplary embodiment of the invention;

FIG. 5 illustrates V/f characteristics employed in the VVVF drive, which is suitable for pumps that require low torque at low speeds;

FIG. 6 illustrates the variation of the electrical equivalence coefficient p as a function of the insolation level for exemplary 3 HP, 5 HP, and 20 HP systems;

FIG. 7 illustrates simulated solar power distribution curves for the cumulative percentage number of hours that the power exceeds a given insolation in a month; and

FIG. 8 illustrates a graph of simulated system performance.

### DETAILED DESCRIPTION OF EXEMPLARY EMBODIMENTS

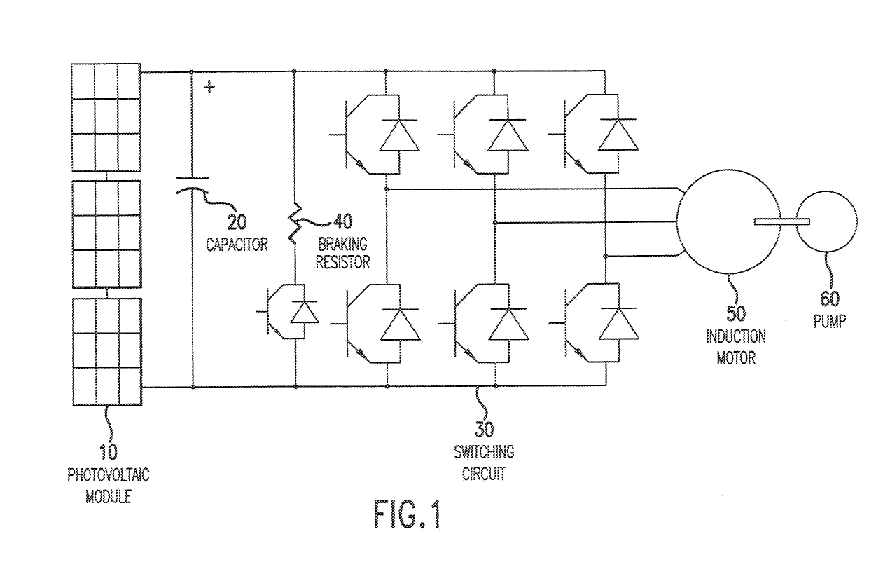

According to exemplary embodiments of the invention, a solar direct pump system employs solar photovoltaic modules to power an AC pump without using a battery. An exemplary embodiment of the system is shown in FIG. 1, in which a series of photovoltaic modules 10 are connected in series to build up the voltage that forms a DC bus. The system also includes a capacitor 20, a switching circuit 30, a braking resistor 40, an induction motor 50, and a pump 60. The pump 60 may be a three-phase AC centrifugal pump, or any other suitable pump that allows variable speed operations.

The capacitor 20 on the DC bus provides very limited energy storage capacity. Further, even the largest related art capacitors would have insufficient energy storage capacity to support the system for more than a few seconds. Due to this lack of energy storage capacity, a power balance must be maintained between the source and the load at all times. Otherwise the bus voltage may collapse or rise to very high levels. A collapse will occur when the photovoltaic modules 10 are generating less than the required power, while an increase will occur when the pump 60 is decelerated too quickly, causing a regeneration of power. An increase will also occur if the photovoltaic modules are generating more power than what is being consumed by the pump 60. Therefore the control mechanism should be fast enough to handle rapidly varying insolation, while being stable enough for day-to-day operation.

In E. Muljadi, “PV Water Pumping with a Peak-Power Tracker Using a Simple Six-Step Square-Wave Inverter,” IEEE Transactions on Industry Applications, vol. 33, no. 3, May/June 1997 (hereinafter “Muljadi”), which is incorporated herein by reference, a six-step square-wave inverter is used. To track the MPP, the inverter is run at a constant frequency for a short period of time, and the frequency is then varied in steps. The control mechanism in Muljadi discloses slow changes in photovoltaic power. As a result, a sudden decrease in irradiance can cause a collapse of the bus voltage.

In G. Terörde et al., “Realistic Maximum-Power-Point Tracker for Direct Water Pump Systems Using AC Motor Drives,” Proc. 2nd World Conference and Exhibition on Photovoltaic Solar Energy Conversion, July 1998 (hereinafter “Terörde”), which is incorporated herein by reference, a different MPP tracker is used that is based on maintaining a constant voltage in the DC bus for a short period of time. The system of Terörde uses two different control loops, and MPP tracking is performed by varying the DC voltage in a small range and calculating the new DC voltage based on the measurements. Terörde discloses that an overall gain in the efficiency of the photovoltaic array of just 2% is achieved, by MPP tracking, compared to common constant voltage tracking.

According to an exemplary embodiment of the present invention, a photovoltaic array is built from 225 Wp multi-crystalline photovoltaic modules 10. The technique may be implemented on various systems, such as a 3 HP portable pump powered by a 2.25 KWp array (10×225 Wp modules in series), a 5 HP pump powered by a 3.825 KWp array (17×225 Wp modules in series), or a 20 HP pump powered by a 15.3 KWp array (17×225 Wp modules in series and 4 such units in parallel). Of course, pumps of any suitable capacity may be used.

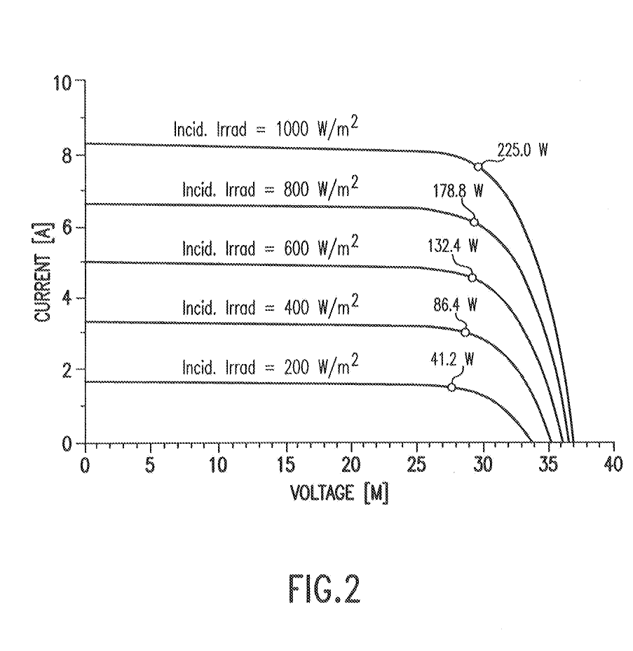

FIG. 2 illustrates the current-voltage (IV) characteristics of a photovoltaic module 10 at different levels of irradiance and at a temperature of 25° C. As shown in FIG. 2, the photovoltaic modules 10 behave as current sources that maintain the same current at a given level of irradiance over a large range of voltages. The MPP is the point on the IV curve where the maximum power is delivered to the load. In FIG. 2 the MPP is shown as a dot with the corresponding maximum power level indicated. After the MPP is reached, the voltage drops rapidly.

It is interesting to note that the MPP voltage is nearly constant over a large variation of irradiance at a given temperature. In G. Makrides et al., “Temperature Behaviour of Different Photovoltaic Systems Installed in Cyprus and Germany,” 17th International Photovoltaic Science and Engineering Conference Volume 93, Issues 6-7, June 2009, Pages 1095-1099 (hereinafter “Makrides”), which is incorporated herein by reference, the variation of different electrical parameters with irradiance and temperature is studied for various types of photovoltaic modules. Makrides suggests that the MPP voltage is nearly independent of irradiance and varies linearly with temperature. According to Makrides, the dependence of the MPP voltage on temperature can be expressed as

Vmpp(T)=Vmpp(25)[1+β(T−25)] (1)

For example, β for the photovoltaic modules 10 may be −0.00496 per centigrade degree.

Unlike electronic systems such as grid-connected inverters, the transient response of the pumping system is inherently slow because of high mechanical inertia. Due to the long transient response time, the feedback time is slow, making it difficult to track the MPP voltage. For example, there will be a significant delay in observing any control signal, such as the increase or decrease of speed, at the pump. Because of the slow response of the system, an MPP tracker will oscillate around the true MPP voltage, rather than operating at the true MPP voltage. The slow response time may also cause instability in the system.

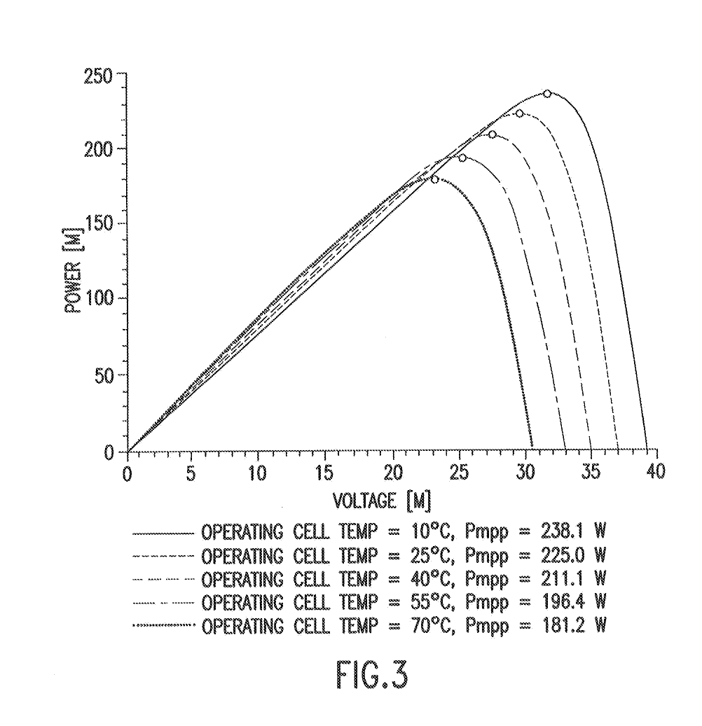

Accordingly, as discussed in detail below, exemplary embodiments of the invention measure the temperature T of the photovoltaic module 10 and compute the MPP voltage V_{MPP(T)} directly from the module temperature T. The MPP voltage V_{MPP(T)} is then used to control the frequency f, or the voltage-to-frequency ratio V/f, or both. FIG. 3 illustrates the variation of power as a function of voltage at different photovoltaic module temperatures and at a fixed incident irradiance of 1000 W/m².

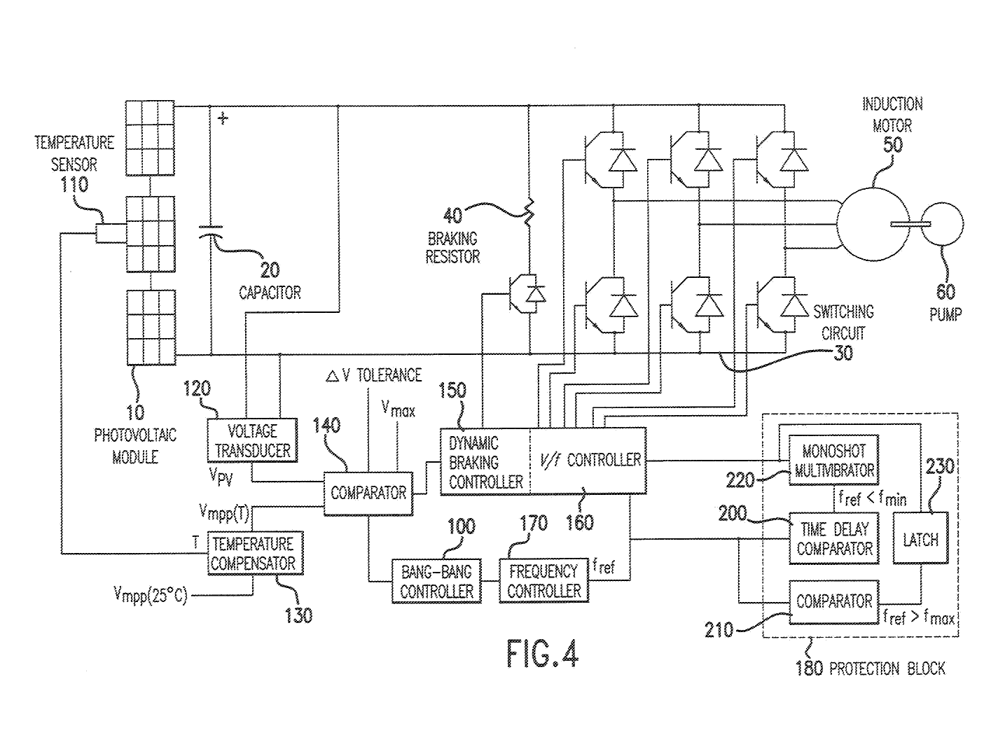

FIG. 4 illustrates a schematic diagram of the system shown in FIG. 1 in conjunction with various control blocks according to an exemplary embodiment of the invention. The drive and control units may be a mix of analog and digital circuits. For example, the drive unit may he a VVVF drive that generates a pulse width modulation (PWM) output.

For centrifugal pumps, such as the pump 60 shown in FIG. 4, the power P and the rotational speed ωₙ are related as

P=kωₙ³ (2)

Here k is a proportionality constant and ωₙ is the rotational speed of the pump 60. The torque τ and rotational speed ωₙ are related as

τ=kωₙ² (3)

By changing the frequency f, the rotational speed ωₙ of the pump 60 can be varied, and therefore the torque τ and the power P can be controlled. Moreover, by keeping the V/f ratio constant, the flux in the stator of the induction motor 50 can be kept constant. As a result the torque τ will remain, constant, even at very low rotational speeds ωₙ. However, this is not required for pump applications, because most pumps do not maintain a constant flow rate over variable speeds. Therefore, at slow speeds, the flow rate and the torque requirements are low.

The constant V/f ratio for the constant torque τ is based on the assumption that there is a negligible voltage drop across the stator of the induction motor 50. However, this assumption does not hold true at low voltages. Therefore, the V/f ratio may instead be modified by the V/f controller 160 to compensate for the voltage drop across the stator at low voltages.

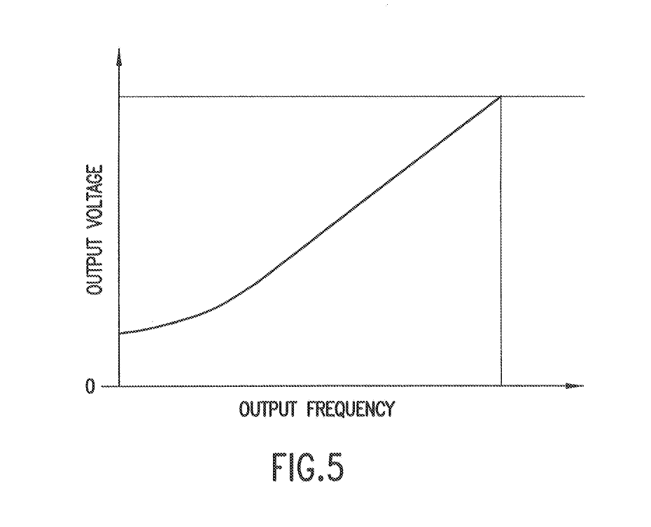

FIG. 5 illustrates an example of a V/f ratio that may be employed by the V/f controller 160, which may be a VVVF drive. In FIG. 5, the region shown is the constant torque region of the induction motor 50 using the VVVF drive. In this region, the system can operate at any torque τ required by the pump 60 that follows conservation of energy, such that the amount of solar-generated energy equals the amount of energy consumed by the pump 60. The torque τ is limited only by the maximum rated torque defined at the base voltage and the base frequency.

An object of the invention is to keep the bus voltage within tight tolerance levels and suppress any deviation in the least possible time. Therefore, as shown in FIG. 4, a bang-bang controller 100 may be employed instead of a proportional-integral (PI) controller. A voltage transducer 120 measures the actual photovoltaic bus voltage Vₚᵥ. A temperature compensator 130 computes the MPP voltage V_{mpp(T)} by using equation 1, taking into account the actual temperature T of the photovoltaic module 10 as measured by a temperature sensor 110 at the photovoltaic module 10. In the present exemplary embodiment, all of the photovoltaic modules 10 are assumed to have the same temperature T. However, if there is a temperature gradient across the photovoltaic modules 10, additional temperature sensors 110 may be provided to measure the temperature T of different photovoltaic modules 10. The average of the temperatures T may then be provided to the temperature compensator 130.

A comparator 140 then compares the photovoltaic bus voltage V_{PV} with the MPP voltage V_{mpp(T)}. Based on the following conditions, the bang-bang controller 100 generates output as follows:
If Vₚᵥ>Vₘₚₚ+ΔV, the output is active high
If Vₚᵥ<Vₘₚₚ, the output is active low
   Here ΔV is the allowed tolerance. For example, the value of ΔV may be 15 V, or any other suitable value. If Vₘₚₚ≦Vₚᵥ≦Vₘₚₚ+ΔV, no output is generated, because the photovoltaic bus voltage V_{PV} is within its target range.

As shown in FIG. 4, a frequency controller 170 increases the frequency for an active high output, and decreases the frequency for an active low output. The frequency controller 170 outputs the reference frequency f_{ref}, which is input to the V/f controller 160 for controlling the V/f ratio. The V/f controller 160 may independently control the voltage and the frequency of the system. Based on the reference frequency f_{ref}, the V/f controller 160 computes the appropriate voltage from the graph shown in FIG. 5.

The rate of increase or decrease in frequency is limited by the maximum allowed acceleration accₘₐₓ and deceleration decₘₐₓ in frequency, respectively, both of which are estimated based on the size of the system. The maximum allowed deceleration decₘₐₓ may be kept slightly lower than optimal to allow for a rapid decrease in the irradiance. For example, for the 3 HP system, accₘₐₓ=10 Hz/Sec and decₘₐₓ=12 Hz/Sec; for the 5 HP system, accₘₐₓ=7 Hz/Sec and decₘₐₓ=9 Hz/Sec; and for the 20 HP system, accₘₐₓ=3.5 Hz/Sec and decₘₐₓ=5 Hz/Sec.

When the irradiance falls suddenly, the rotational speed ωₙ of the induction motor 50 must be reduced to match the lower available power. If the deceleration happens too slowly, the bus voltage may collapse. However, a fast change may cause regeneration, and there may be a sudden influx of power from the pump 60 that may cause a sudden increase in the bus voltage beyond safe values. To mitigate this issue, the deceleration rate may be set to be less than optimal, and every time the photovoltaic bus voltage Vₚᵥ goes beyond a set high point Vₘₐₓ, a dynamic braking controller 150 may be switched on to dissipate excess energy in the braking resistor 90. In contrast, an optimal deceleration rate occurs when all power sources are removed and the pump is allowed to slow down on its own. The duty ratio of the braking resistor 90 may be proportional to the overshoot of the photovoltaic bus voltage Vₚᵥ above the high point Vₘₐₓ. The comparator 140 may be used to compare the photovoltaic bus voltage Vₚᵥ and the high point Vₘₐₓ.

It is typically recommended not to operate pumps continuously at a low speed. This is because of reduced thermal efficiencies at low speeds. To avoid running the pump 60 at low speeds for extended periods of time, a special protection block 180 may be employed. The protection block 180 includes a time delay comparator 200 built using a simple RC circuit or any other suitable components, a comparator 210, and an astable monoshot multivibrator 220. The time delay comparator 200 compares the reference frequency f_{ref} with a fixed low frequency limit fₘᵢₙ. If f_{ref}<fₘᵢₙ for a specific amount of time, the time delay comparator 200 sends a trigger to the monoshot multivibrator 220, which switches on for some set time. When the monoshot multivibrator 220 is on, the pump 60 is switched off. For example, the time delay for the time delay comparator 200 may be 2 min, fₘᵢₙ may he 15 Hz, and the monoshot multivibrator 220 may trigger for 10 min. In this example, whenever the pump 60 runs at less than 15 Hz for more than two minutes, the entire system switches off for the next 10 minutes. Afterward the system restarts, and if the pump 60 still runs at less than 15 Hz for two minutes, the whole cycle is repeated. fₘᵢₙ may be set lower than 15 Hz for submersible pumps, which typically have better heat dissipation capacity.

Another common problem with pumps is dry running. Running a pump dry for an extended period can cause considerable damage to the pump. Although simple flow detection mechanisms work well with standard pumps, this is not a good solution for solar pumping applications in which the flow can vary over a wide range without actually dry running. In fact, the flow can be zero at low insolations, wrongly indicating dry run if such a system is used. Torque is often used as a parameter to detect dry running. When implemented in a variable-speed application, torque must be corrected for speed for reliable operation (see U.S. Pat. No. 7,080,508 to Stavale et al., which is incorporated herein by reference). It is important to note that a system powered directly by solar energy is power-limited.

Normally there is insufficient power for the pump 60 to exceed its rated speed. However, in the case of dry run, the pump will run at a much higher speed than its rated speed. This effect is used to detect dry running. As shown in FIG. 4, the comparator 210 compares f_{ref} with f ₘₐₓ, which is set marginally higher than the rated speed of the pump 60. If f_{ref} exceeds fₘₐₓ the comparator 210 triggers a latch 230 that causes the system to shut down.

An advantage of the system shown in FIG. 4 is that the system is inherently safe because the photovoltaic modules 10 are current-limited. Therefore, even if a short occurs, the current stays within safe limits. Moreover, no current-limiting circuit is required at startup when the capacitor 20 is discharged and acts like a very low impedance load for some time. Further, the system may always be kept on. The pump 60 may automatically start in the morning and run until dusk. The protection block 180 ensures that the pump 60 does not overheat during sunrise, sunset, or cloudy days when the irradiance is continuously low for some time. The performance of the system may be measured and logged over time, along with the prevailing environmental conditions such as irradiance, ambient temperature, module temperature, and wind speed.

The behavior of a solar direct pump according to exemplary embodiments of the invention is very different from the related art pumps described above. The system performance depends on many parameters such as insolation, temperature, pump power rating, head, and mechanical transient response of the system. The head may be the total dynamic head, which is the sum of the static head, static lift, and friction less. The static head is the total height to which the liquid is pumped, the static lift is the total height from which the liquid is pumped, and the friction loss models the losses due to friction and turbulence in the pipes. The friction loss can be computed by using the Darcy-Weisbach equation. To perform an unbiased performance study, a new performance evaluation technique may be employed, which is somewhat independent of pump power rating and head. Moreover, the evaluation methodology may be simple enough for anyone to interpret, and easy enough to predict and simulate using statistical meteorological data.

Equivalent Electrical Hours (EEH) may be used as a performance evaluation measure for solar direct pumps according to exemplary embodiments of the invention. EEH indicates the number of hours that the pump 60 needs to be run by grid power to deliver the same water yield as that of the system run by solar. The basic idea of using EEH as a performance measure comes from the fact that it is independent of pump power ratings and head for low head applications, and only depends on the solar power profile at its geographical location, which can be obtained from publicly available databases such as the Surface Meteorology and Solar Energy, Atmospheric Science Data Center of NASA (http://eosweb.larc.nasa.gov/sse/) or the Global Solar Radiation Database of Meteonorm (http://www.meteonorm.com).

The electrical equivalence coefficient ρ at a particular insolation level l is defined as

$$ρ ( I ) = \frac{Flowrate ( I )}{Flowrate ( running on grid power )} \qquad ( 4 )$$

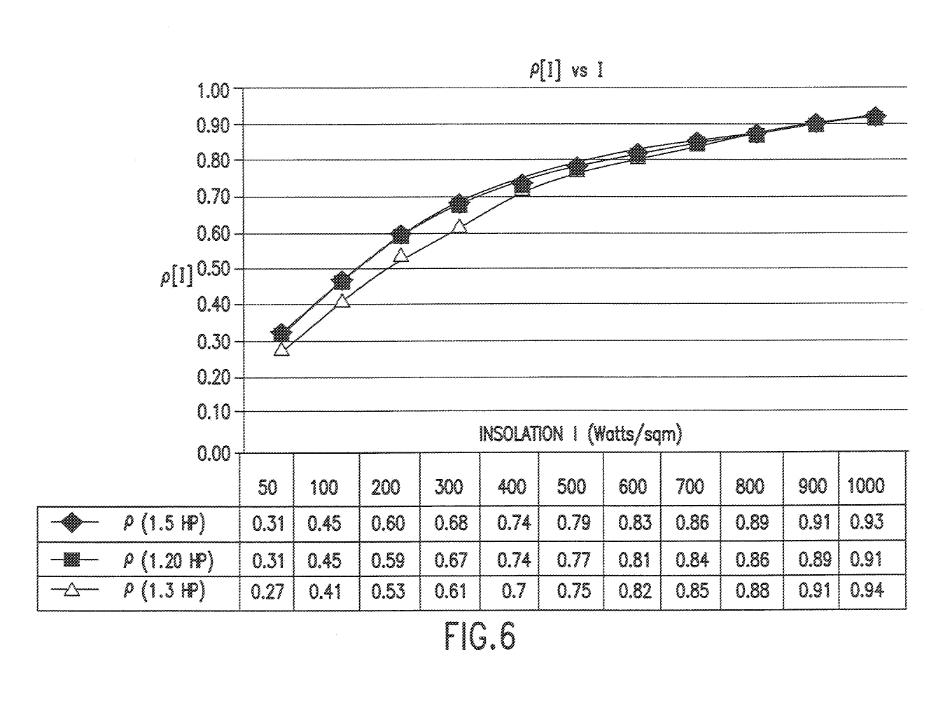

ρ(I) is obtained for the three exemplary systems discussed above. The heads associated with each pump are different. FIG. 6 illustrates ρ as a function of insolation I for the exemplary 3 HP, 5 HP, and 20 HP systems. The 5 HP and 20 HP pumps are surface mounted with an approximate total dynamic head of 6 m and 3 m, respectively. The 3 HP pump is submersible with an approximate total dynamic head of 10 m. As can be seen in FIG. 6, ρ(I) is similar for all three systems, even though they are quite different in terms of pump power ratings and head.

Accordingly, the EEH over the time period TP can be computed as

EEH=∫₀^{TP}ρ(I)dt (5)

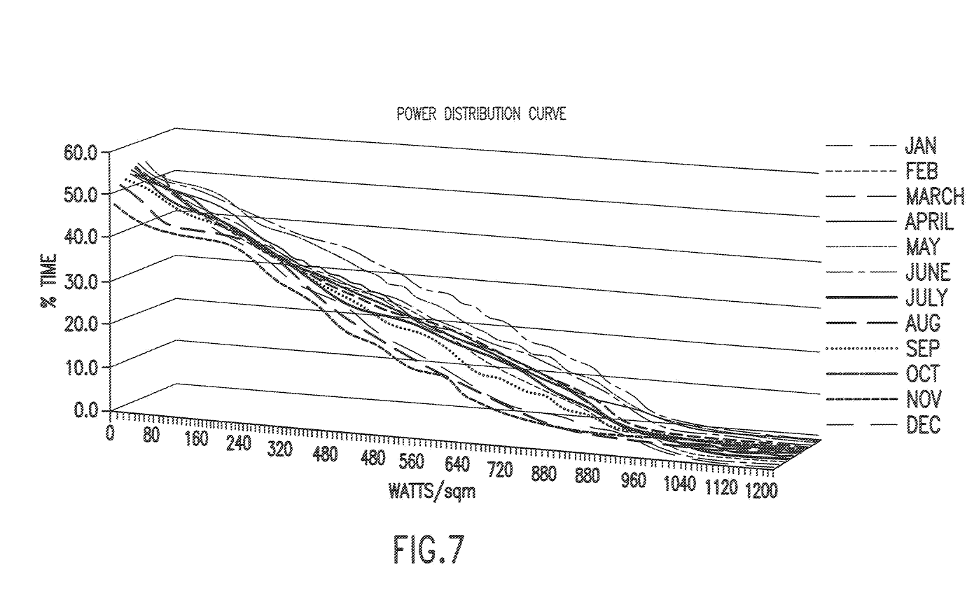

For simulations, insolation data may be obtained and averaged over a large period of time (see NASA and Meteonorm databases), and various mathematical models may be applied to obtain an hourly power distribution for any particular location. For instance, synthetic meteorological hourly data from only monthly known values may be obtained using models described by R. J. Aguiar et al., “Simple Procedure for Generating Sequences of Daily Radiation Values Using a Library of Markov Transition Matrices,” Solar Energy Vol. 40, No. 3, pp. 269-279, 1988 (hereinafter “Aguiar I”) and R. J. Aguiar et al., “TAG: a Time-dependent, Autoregressive, Gaussian Model for Generating Synthetic Hourly Radiation,” Solar Energy ‘Vol. 49, No. 3, pp. 167-174, 1992 (hereinafter “Aguiar II”), both of which are incorporated herein by reference. Similarly, using transposition model incident irradiance on a tilted plane can be computed from the horizontal irradiance data, such as in R. Perez et al., “Modeling Daylight Availability and Irradiance Component from Direct and Global Irradiance,” Solar Energy 44, no. 5, pp. 271-289, 1990 (hereinafter “Perez”), which is incorporated herein by reference. FIG. 7 illustrates simulated power distributions obtained using models described in Aguiar II and Perez for the location where the experiment was carried out by using data from the NASA database.

Once the hourly power distribution is obtained, the average insolation at any particular hour is known. If Iₜ is the insolation at any particular hour t, then the EEH over the time period can be computed as

EEH=Σρ(Iₜ) (6)

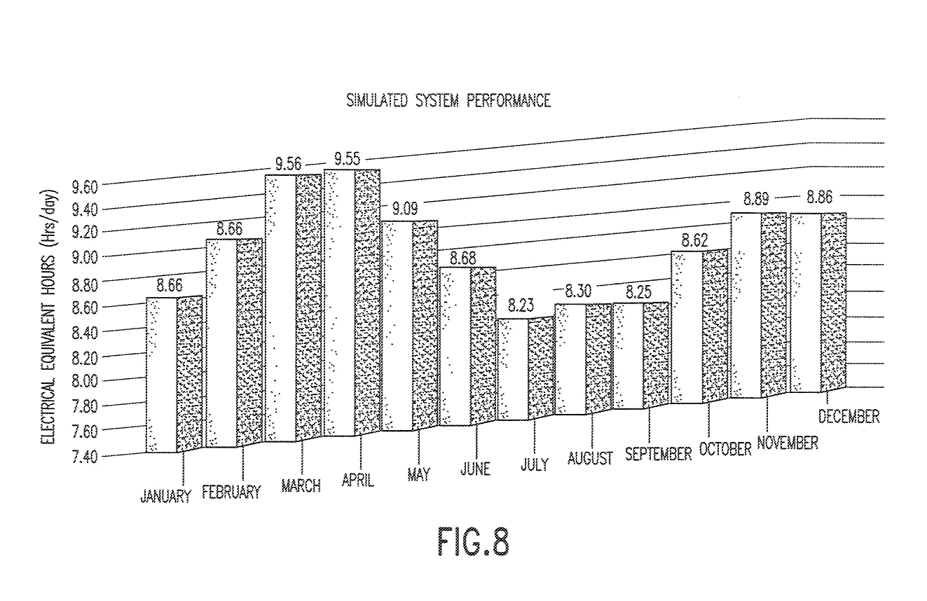

Because ρ is known only for discrete values of I, the value of ρ for other values of I can be obtained using linear interpolation. The average daily EEH obtained from simulated data is shown in FIG. 8. For example, the actual value of the average daily EEH for the month of February was 8.81 for the 20 HP pump, 8.86 for the 5 HP pump, and 8.87 for the 3 HP pump. These results are close to the simulated value of 9.07, and the standard deviation among the EEH of the three systems is negligible, which confirms the efficacy of the performance evaluation and simulation model. It must he noted that the value of ρ is obtained at varying module temperatures, as it is very difficult to keep the module temperatures fixed with varying insolation. A more complex evaluation model where ρ is corrected for temperature may be used to obtain better simulation.

Exemplary embodiments of the invention include a solar water pumping system that is capable of being operated without any battery storage device. The system maintains a power balance on the DC bus by constantly monitoring the voltage and adjusting the speed of the pump. The feedback loop tries to maintain the voltage at a constant value that is compensated for module temperature. Therefore the system operates near the MPP voltage. This method of operation ensures system stability under rapidly changing weather conditions, yet operates at a high overall efficiency. A new way of comparing, estimating, and simulating the performance of such a system is also discussed. The method is suitable for comparing widely different systems employed in widely different pumping applications.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for controlling an alternating current (AC) pump, the system comprising:
a photovoltaic module;
a temperature sensor that measures a temperature of the photovoltaic module;
a calculator that calculates a maximum power point (MPP) voltage of the photovoltaic module based on the temperature of the photovoltaic module; and
a frequency controller that adjusts a reference frequency of power supplied to the pump based on the MPP voltage.

2. The system recited in claim 1, wherein if a photovoltaic bus voltage exceeds a sum of the MPP voltage and a tolerance voltage, the frequency controller increases the reference frequency.

3. The system recited in claim 1, wherein if the MPP voltage exceeds a photovoltaic bus voltage, the frequency controller decreases the reference frequency.

4. The system recited in claim 1, further comprising a voltage-to-frequency ratio controller that adjusts a voltage-to-frequency ratio based on the MPP voltage.

5. The system recited in claim 4, wherein the voltage-to-frequency ratio controller adjusts the voltage-to-frequency ratio to compensate for a voltage drop across a stator of an induction motor coupled to the pump.

6. The system recited in claim 4, wherein the voltage-to-frequency ratio controller is a variable voltage variable frequency (VVVF) drive.

7. The system recited in claim 1, further comprising:
a braking resistor that is connected in parallel with the photovoltaic module; and
a braking controller that dissipates excess energy in the braking resistor if a photovoltaic bus voltage exceeds a maximum voltage.

8. The system recited in claim 1, further comprising:
a time delay comparator that compares the reference frequency with a minimum frequency; and
a monoshot multivibrator that switches off the pump if the minimum frequency exceeds the reference frequency for a length of time.

9. The system recited in claim 1, further comprising:
a comparator that compares the reference frequency with a maximum frequency; and
a latch that switches off the pump if the reference frequency exceeds the maximum frequency.

10. A method for controlling an alternating current (AC) pump, the method comprising:
measuring a temperature of a photovoltaic module;
calculating a maximum power point (MPP) voltage of the photovoltaic module based on the temperature of the photovoltaic module; and
adjusting a reference frequency of power supplied to the pump based on the MPP voltage.

11. The method recited in claim 10, further comprising increasing the reference frequency if a photovoltaic bus voltage exceeds a sum of the MPP voltage and a tolerance voltage.

12. The method recited in claim 10, further comprising decreasing the reference frequency if the MPP voltage exceeds a photovoltaic bus voltage.

13. The method recited in claim 10, further comprising adjusting a voltage-to-frequency ratio based on the MPP voltage.

14. The method recited in claim 13, wherein the voltage-to-frequency ratio is adjusted to compensate for a voltage drop across a stator of an induction motor coupled to the pump.

15. The method recited in claim 10, further comprising dissipating excess energy in a braking resistor that is connected in parallel with the photovoltaic module if a photovoltaic bus voltage exceeds a maximum voltage.

16. The method recited in claim 10, further comprising:
comparing the reference frequency with a minimum frequency; and
switching off the pump if the minimum frequency exceeds the reference frequency for a length of time.

17. The method recited in claim 10, further comprising:
comparing the reference frequency with a maximum frequency; and
switching off the pump if the reference frequency exceeds the maximum frequency.

18. A system for controlling an alternating current (AC) pump, the system comprising:
a photovoltaic module;
means for measuring a temperature of the photovoltaic module;
means for calculating a maximum power point (MPP) voltage of the photovoltaic module based on the temperature of the photovoltaic module; and
means for adjusting a reference frequency of power supplied to the pump based on the MPP voltage.
